(19) United States
(12) Patent Application Publication
(10) Pub. No.: US 2019/0364133 A1
(43) Pub. Date: Nov. 28, 2019

(54) DISPLAY PROCESSING METHOD AND APPARATUS, AND ELECTRONIC TERMINAL THEREFOR

(71) Applicant: UCWEB SINGAPORE PTE. LTD., Singapore (SG)

(72) Inventors: Ming DONG, Beijing (CN); Yi TAN, Beijing (CN); Lulu PAN, Beijing (CN); Yuepeng HU, Beijing (CN)

(21) Appl. No.: 16/138,910

(22) Filed: Sep. 21, 2018

Related U.S. Application Data
(63) Continuation of application No. PCT/CN2018/087893, filed on May 22, 2018.

(51) Int. Cl. H04L 29/08; G06F 3/0488; G06F 3/0489; G06F 3/0485

(52) U.S. Cl. CPC H04L 67/36; G06F 3/0485; G06F 3/0489; G06F 3/04883

(57) ABSTRACT

A display processing method and apparatus and an electronic terminal therefor are provided. The display processing method includes: determining a display region of data to be loaded according to an anchor position on a display interface; and loading pre-acquired display data to the display region of the data to be loaded for display. In this way, the problem that some pre-view content fails to be loaded to the display interface in real time for display due to impacts by the network speed, for example, the phenomenon of blank backgrounds is addressed, such that user experience is improved.

### CROSS-REFERENCE TO RELATED DISCLOSURES

The present disclosure is a continuation of international disclosure No. PCT/CN2018/087893 filed on May 22, 2018, which is hereby incorporated by reference in its entirety.

### TECHNICAL FIELD

Embodiments of the present disclosure relate to the technical field of data processing, and in particular, relate to a display processing method and apparatus, and a storage medium and an electronic terminal therefor.

### BACKGROUND

With the rapid development of the Internet, acquisition of information is greatly facilitated. By a combination of the Internet and mobile terminals, ways of acquiring information are more diversified and abundant. With emergence of large data, a large amount of content may be aggregated and screened out from massive data for customized calculation featuring great retention from users, and accurate information recommendation or acquisition.

As described above, conventional information acquisition highly relies on the Internet. With respect to user experience, one of the most important experiences is the speed of acquiring information, which is also referred to as timeliness. However, the speed of acquiring information may be directly affected by the network speed of the Internet. A higher network speed ensures a higher speed of acquiring information and a better user experience. On the contrary, a lower network speed indicates a lower speed of acquiring information and a poorer user experience. For example, in some short video disclosure, users preview content via gesture actions, and finally select desired video content to watch. However, due to the network speed, some previewed content may not be loaded to and then displayed on the display interface in real time. For example, blank backgrounds frequently appear, and as a result user experience is poor.

### SUMMARY

In view of the above, one technical problem to be solved by embodiments of the present disclosure is to provide a display processing method and apparatus, and a storage medium and an electronic terminal therefor, to address or mitigate the above technical defects in the prior art.

Embodiments of the present disclosure employ the following technical solutions:

Embodiments of the present disclosure provide a display processing apparatus. The apparatus includes:

determining a display region of data to be loaded according to an anchor position on a display interface; and

loading pre-acquired display data to the display region of the data to be loaded for display.

Embodiments of the present disclosure further provide a display processing apparatus. The apparatus includes:

a first program unit, configured to determine a display region of data to be loaded according to an anchor position on a display interface; and

a second program unit, configured to load pre-acquired display data to the display region of the data to be loaded for display.

Embodiments of the present disclosure further provide a storage medium, wherein the storage medium stores computer-executable instructions, which, when being executed by a processor, cause the processor to perform the following steps:

determining a display region of data to be loaded according to an anchor position on a display interface; and

loading pre-acquired display data to the display region of the data to be loaded for display.

Embodiments of the present disclosure further provide an electronic terminal. The electronic terminal includes a storage medium and a processor, wherein the storage medium stores computer-executable instructions, which, when being executed by the processor, cause the processor to perform the following steps:

determining a display region of data to be loaded according to an anchor position on a display interface; and

loading pre-acquired display data to the display region of the data to be loaded for display.

In embodiments of the present disclosure, a display region of data to be loaded is determined according to an anchor position on a display interface; and pre-acquired display data is loaded to the display region of the data to be loaded for display. In this way, the problem that some pre-view content fails to be loaded to the display interface in real time for display due to impacts by the network speed, for example, the phenomenon of blank backgrounds is addressed, such that user experience is improved.

### BRIEF DESCRIPTION OF THE DRAWINGS

Some specific embodiments of the present disclosure are described in detail hereinafter in an exemplary manner instead of a non-limitative manner with reference to the accompanying drawings. In the drawings, like reference numerals denote like or similar parts or elements. A person skilled in the art should understand that these drawings are drawn to scale. Among the drawings:

FIG. 1 is a schematic structural diagram of an electronic terminal according to the first embodiment of the present disclosure;

FIG. 2 is a schematic flowchart of a display processing method according to the second embodiment of the present disclosure;

FIG. 3 is a schematic flowchart of a display processing method according to the third embodiment of the present disclosure;

FIG. 4 is a schematic diagram illustrating loading in a specific disclosure scenario according to the fourth embodiment of the present disclosure; and

FIG. 5 is a schematic structural diagram of a display processing apparatus according to the fifth embodiment of the present disclosure.

### DETAILED DESCRIPTION

Nevertheless, it is not necessary to require that any technical solution according to the embodiments of the present disclosure achieves all of the above technical effects.

A display processing method and apparatus according to the embodiments of the present disclosure may be applied to an electronic terminal as illustrated in FIG. 1 according to Embodiment of the present disclosure.

In the embodiments of the present disclosure, the electronic terminal is a mobile terminal device. For example, the electronic terminal may include a smart phone, a tablet computer, an electronic reader, a Moving Picture Experts Group Audio Layer III (MP3) player, a Moving Picture Experts Group Audio Layer IV (MP4) player, a laptop computer, a wearable mobile terminal and the like.

As illustrated in FIG. 1, the electronic terminal includes a memory 101 (or referred to as a storage medium), a storage controller 102, one or more (only one processor is illustrated in the drawing) processors 103, a peripheral interface 104, a radio frequency module 105, an audio module 106, a display screen 107, and a sensor 108, for example, an acceleration sensor, a distance sensor, or the like. These components or elements are in communication with each other via one or more communication buses/signal cables 116.

The memory 101 may be configured to store software disclosures and modules, for example, the program instructions/modules corresponding to the display processing method and apparatus according to the embodiments of the present disclosure. The memory 101 may be configured to store software disclosures and modules, for example, the program instructions/modules corresponding to the display processing method and apparatus according to the embodiments of the present disclosure. The processor 103 is configured to run the software disclosures and modules stored in the memory 101, to implement various function disclosures and data processing, e.g. to implement the display processing method according to the embodiment of the present disclosure.

The memory 101 may include a high-speed random memory, and may further include a non-volatile memory, for example, one or a plurality of magnetic storage devices, flash memories, or other non-volatile solid memories. The processor 103 and the other possible components or elements may access the memory 101 under control of the storage controller 102.

The peripheral interface 104 couples various input/output apparatuses to the processor 103 and the memory 101. In some embodiments, the peripheral interface 104, the processor 103 and the storage memory 102 may be implemented in a single chip. In some other embodiments, these components or elements may be respectively implemented by independent chips.

The radio frequency module 105 is configured to receive and send electromagnetic waves, and implement conversion between the electromagnetic waves and electrical signals so as to communicate with the communication network or other devices.

The audio module 106 is configured to provide an audio interface for a user, which may include one or more microphones, one or more speakers and an audio circuit.

The display screen 107 is configured to provide an output and input interface between the electronic terminal and the user. Specifically, the display screen 107 displays content outputs for the user, wherein the output content may include texts, graphs, videos and any combination thereof

The distance sensor in the sensor 108 is configured to sense a distance between the electronic terminal and the user. For example, during a conversation, when the screen of the electronic terminal is attached to the face of the user, the distance sensor may automatically detect the distance between the electronic terminal and the user. When the distance is less than a value, the screen may be turned off, and the electronic terminal may not receive a screen touch event of the user, thereby preventing mis-operations during the conversation. In addition, the distance sensor may be further configured to implement control such as floating and the like.

The acceleration sensor in the sensor 108 is a sensor that is capable of sensing an acceleration and converting the acceleration into a useful output signal.

It may be understood that the structure as illustrated in FIG. 1 is illustrative, and the electronic terminal may further include more or less components or elements as relative to those illustrated in FIG. 1, or have different configurations as relative to the structure illustrated in FIG. 1. The components or elements as illustrated in FIG. 1 may be implemented by hardware, software or a combination of the hardware and the software.

In an embodiment of the present disclosure, the electronic terminal is provided with a client. The client may be a browser or may be third-party disclosure software, which corresponds to a server and provides services for a user, for example, an electronic reading service for playing local or online visualized text files.

In an embodiment of the present disclosure, the display interface may include a display interface of a client of the electronic terminal, which includes an interface for practically displaying context, and a progress label for displaying a browse progress of the displayed context. The size of the display interface is related to the settings of the display interface of the client. If the display interface set on the client is in a full-screen mode, the size of the display interface may be the same as the size of the display region of the display screen of the electronic terminal (for example, a display screen 107). If the display interface set on the client is smaller than the display screen of the electronic terminal, the size of the display interface is the size of the display interface that is practically set.

For better understanding of the technical solutions of the embodiments of the present disclosure by a person skilled in the art, the technical solutions of the present disclosure are clearly and completely described with reference to the accompanying drawings of the embodiments of the present disclosure. Apparently, the described embodiments are only a part of the embodiments of the present disclosure, rather than the entire embodiments. Based on the embodiments of the present disclosure, all other embodiments derived by persons of ordinary skill in the art without any creative efforts shall fall within the protection scope of the present disclosure.

Specific implementations of the embodiments of the present disclosure are further described hereinafter with reference to the accompanying drawings of the present disclosure.

In the technical solution according to the embodiments of the present disclosure, firstly a display region of data to be loaded is determined according to an anchor position on a display interface; and pre-acquired display data is loaded to the display region of the data to be loaded for display. Correspondingly, for performing these steps, corresponding program units are configured, including, a first program unit and a second program unit. For determining better technical effects or solving further technical problem, some technical processing steps and corresponding program units are added. The details thereof may be referenced to the embodiments hereinafter.

In the embodiments hereinafter of the present disclosure, description is specifically given by using a third-party disclosure applicable to a short video type for content recommendation or update based on the feed stream as an example.

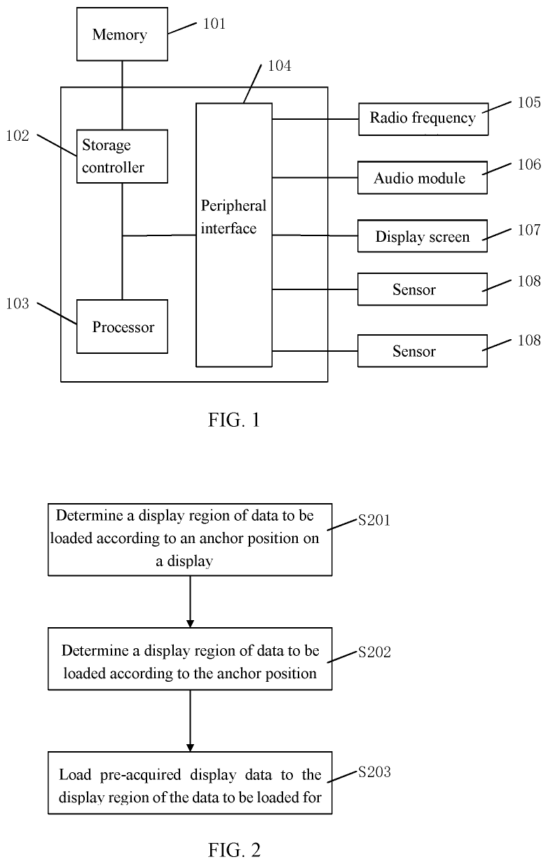

FIG. 2 is a schematic flowchart of a display processing method according to the second embodiment of the present disclosure. As illustrated in FIG. 2, the method includes the following steps:

Step S201: An anchor position on a display interface is determined according to a display operation event.

Specifically, in this embodiment, the anchor position on the display interface is determined according to a gesture swipe operation event or a key operation event, wherein the gesture swipe operation event or the key operation event is used as the display operation event.

For example, on an electronic terminal equipped with a touch display screen, if it is such configured that content preview may be practiced by a gesture swipe action, the anchor position on the display interface may be determined by capturing a gesture swipe action event generated by the user on the touch display screen when the user previews video content after starting a short video disclosure. Alternatively, if it is such configured that content preview may be practiced by a key operation, the anchor position on the display interface may be determined by capturing a gesture swipe action event generated by the user on the touch display screen when the user previews video content after starting a short video disclosure.

In this embodiment, the anchor position may be a position where a page on the display interface scrolls and finally reaches due to the gesture swipe operation event. The position may be a middle region on a predefined display interface, or may be any position where content on the page is completely presented for the user. Specifically, for example, with respect to a short video disclosure, the display interface of the electronic terminal is generally provided with a plurality of display frameworks, where each display framework displays one piece of short video content. In this case, the anchor position may be specification a position of the display framework at the upper left corner in the middle region of the display interface. Nevertheless, the anchor position may also be the display framework in a row in the middle region.

S202: A display region of data to be loaded is determined according to the anchor position on the display interface.

In this embodiment, in step S202, a display framework corresponding to the anchor position may be specifically determined according to the anchor position on the display interface and a physical position identifier of a display framework planed on the display interface, wherein the display region of the data to be loaded includes the display frame corresponding to the anchor position.

Specifically, a display framework array is constructed on the display interface, wherein the display framework array includes a plurality of display frameworks having different physical positions, wherein a position identifier is assigned to each physical position. The display framework array may be constructed prior to step S201, or may be constructed between step S202 and step S203.

Specifically, in constructing the display framework array, the size of the display framework may be determined according to a display dimension of the short video uploaded to the background. That is, the dimensions of the display frameworks in the display framework array are not consistent. Further, the display frameworks at different physical positions are recorded by virtue of forming a queue of the positions of the display frameworks, to ensure an order of loading the display data. That is, the display data is preferentially loaded to the display framework with the position identifier being at a front part of the queue; and if a video stream is to be filled, this display framework is preferably filled with the video stream.

S203: Pre-acquired display data is loaded to the display region of the data to be loaded for display.

In this embodiment, the pre-acquired display data may be cover display pictures suitable for different display frameworks that are loaded before the page scrolls and stops at the anchor position. Specifically, these downloaded cover display pictures may form a resource queue, and a preferentially loaded cover display picture is closer to the head of the resource queue. The order of preferentially loading the pictures may be consistent with the order of filling the video streams in the queue of the positions of the display frameworks.

It should be noted that the order or priorities of preferentially loading the cover display pictures may be related to user preferences or user habits. That is, by large-data analysis on the collected labels of videos watched by the user, the cover display picture that most matches the label is preferentially loaded to the display framework corresponding to the anchor position. Nevertheless, it should be noted that with respect to a short video stream disclosure, the cover display picture may be the picture at a frame that most attracts the user, or the picture at a frame that most embodies the feature of the video stream.

Specifically, with respect to a short video stream disclosure, six display frameworks are configured on the display interface, and the anchor position is defined to be the position where two display frameworks in the middle region are located. In this case, after the page scrolls and stops due to a gesture swipe action of the user on the display interface, for example, the displayed page scrolls by four screens during this period, in scrolling to the fourth screen, six cover display pictures that are originally to be loaded to the display framework in the third screen are pre-loaded to form a resource queue. When the displayed page scrolls and stops at the anchor position, two cover display pictures with higher priorities are extracted from the resource queue, and then loaded to the two display frameworks in the middle region. In this way, the problem that a blank page appears because a complete video stream in the display frameworks in the fourth screen need to be practically downloaded in the prior art is addressed, and thus user experience is improved. However, the second screen is invisible to the user, or the user may not practically watch the second screen. Therefore, the video to be originally displayed in the second screen does not need to be processed. That is, the cover display pictures do not need to be downloaded at the background, or the complete video stream does not need to be downloaded to fill the display frameworks in the second screen. In other words, the video to be originally downloaded in the second screen may be considered as a non-interesting video or invalid video for the user.

Analogously, the non-interesting video may be determined according to a gesture swipe operation event, and may not be pre-downloaded. Instead, several display data in a screen prior to the appearance of the anchor position, and the display data is directly loaded to the display frameworks on the display interface in this screen where the anchor position is located when the anchor position appears. In this way, the downloaded data volume is further reduced, and impacts caused by the network speed on the user experience are mitigated.

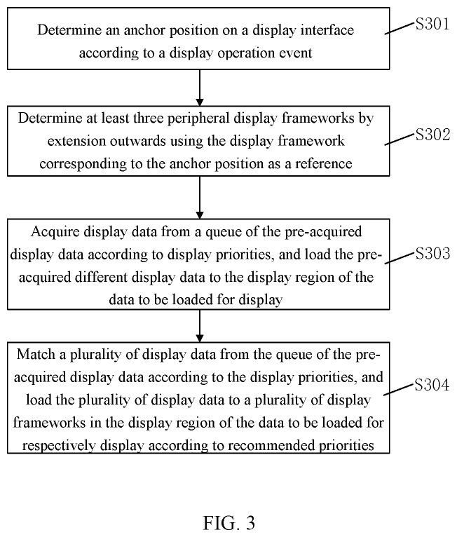

FIG. 3 is a schematic flowchart of a display processing method according to the third embodiment of the present disclosure. As illustrated in FIG. 3, the method includes the following steps (S301-S303):

Step S301: An anchor position on a display interface is determined according to a display operation event.

In this embodiment, step S301 is similar to step S201 in the above embodiment.

Step S302: At least three peripheral display frameworks are determined by extension outwards using the display framework corresponding to the anchor position as a reference.

Different from the above embodiment, in this embodiment, to provide as more as possible videos that accommodate the requirements for the user, after the display framework corresponding to the anchor position is determined, a plurality of peripheral display frameworks may be determined by extension outwards from a center (that is, the display framework corresponding to the anchor position) in a radiation manner, to load the pre-downloaded cover display pictures to the display framework corresponding to the anchor position and the plurality of peripheral display frameworks. These cover display pictures are extracted from the corresponding video stream.

Step S303: Display data is acquired from a queue of the pre-acquired display data according to display priorities, and the pre-acquired different display data is loaded to the display region of the data to be loaded for display.

In this embodiment, in step S303, the corresponding display data may be specifically matched from the queue of the pre-downloaded display data according to the display priorities and the dimensional of the display region of the data to be loaded. Accordingly, in step S303 or prior to step S303, an association relationship between the physical position of the display region of the data to be loaded and a resource request sequence is established, such that the plurality of display data is matched from the queue of the pre-acquired display data according to the display priorities in data loading in step S303.

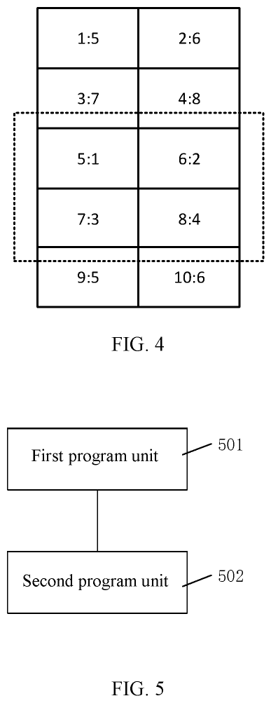

As described above, the cover display pictures may be specifically acquired from a resource queue and loaded to the display frame with the corresponding priority directly according to a queue of the positions of the display frameworks and the resource queue. For example, as illustrated in FIG. 4, a schematic diagram of loading in a specific disclosure scenario according to the fourth embodiment of the present disclosure is given. If ten display frameworks are configured on the display interface, the formed queue of the positions of the display frameworks is 1//2/3/4/5/6/7/8/9/10 represented by position identifiers. If the anchor position defined when a displayed page stops scrolling is the first display framework in the third row, the position identifier of the display framework is 5, and three display frameworks with the position identifiers 6/7/8 are determined as the peripheral display frameworks by extension towards the lower left corner using the display framework with the position identifier 5 as the center. That is, in this embodiment, the pre-downloaded cover display pictures need to be loaded to the four display frameworks with the position identifier 5/6/7/8, wherein the loading priorities are in a descending order. That is, the cover display picture is preferentially loaded to the display framework with the position identifier 5, and analogously the cover display picture is last loaded to the display framework with the position identifier 8.

Step S304: A plurality of display data is matched from the queue of the pre-acquired display data according to the display priorities, and the plurality of display data is loaded to a plurality of display frameworks in the display region of the data to be loaded for respectively display according to recommended priorities.

In this embodiment, if the priorities of the display data in the queue of the display data are represented by, for example, 1/2/3/4, a smaller number indicates a higher priority. In loading and display, the cover display picture with the priority 1 is firstly loaded to the display framework with the position identifier 5, and analogously the cover display picture with the priority 4 is loaded to the display framework with the position identifier 8.

Alternatively, in other embodiments, the loading pre-acquired display data to the display region of the data to be loaded for display may include: loading default display data to the display region of the data to be loaded for display.

In addition, in the above embodiment, only one cover display picture may be pre-downloaded. Nevertheless, alternatively, in an anchoring process, a plurality of display data is pre-downloaded to a local front end, and the pre-downloaded display data is loaded to the display region of the data to be loaded for scroll display. Specifically, in the anchoring process, display data sets may be pre-downloaded to the local front end, wherein each display data set includes a plurality of display data; and the plurality of display data in each display data set is loaded to each display framework in the display region of the data to be loaded for scroll display.

Based on any of the above embodiments, upon the last step, a step of acquiring a complete display data stream from a background, and filling the complete display data stream to a display framework may be further added. The display data stream may be a video stream. In the specific filling, with respect to an up-swipe gesture operation and a down-swipe gesture operation, different filling policies are defined. For example, with respect to the up-swipe gesture operation, the video stream with the highest priority may be requested from the background and filled to the corresponding display framework; and with respect to the down-swipe gesture operation, at least two video streams with higher priorities may be requested from the background and filled to two different display framework. In this way, the content most accommodating the requirements of the user is obtained.

In addition, it should be noted that a gesture swipe operation includes a long-press gesture swipe action and a short-press gesture swipe action.

The scroll display of the cover display picture may rely on different types of FEED stream technologies, including, but not limited to, timeline, rank, aggregate, and notice, as long as priorities of content update or loading are defined.

It should be noted that the above short video disclosure based on the feed stream is only exemplified for illustrative purposes. From the perspective of technical essence, the technical solutions according to the present disclosure may be also applicable to any scenario of recommending content or updating content for the user. For example, the technical solutions may be applicable to reading of electronic books. For example, in the reading process of the user, due to multiple consecutive page-turn operations backwards due to mis-operations, content of the book may not be consecutively read. Therefore, the last page of content browsed by the user may be determined prior to the mis-operations, and upon the multiple consecutive page-turn operations, the content is continuously displayed from the last page of content. In this way, continuity of reading content is ensured for the user.

FIG. 5 is a schematic structural diagram of a display processing apparatus according to a fifth embodiment of the present disclosure. As illustrated in FIG. 5, the apparatus includes: a first program unit, configured to determine a display region of data to be loaded based on an anchor position on a display interface; and a second program unit, configured to load pre-acquired display data to the display region of the data to be loaded for display.

In this embodiment, the first program unit is further configured to determine a display framework corresponding to the anchor position based on the anchor position on the display interface and a physical position identifier of a display framework planed on the display interface, wherein the display region of the data to be loaded comprises the display frame corresponding to the anchor position.

Optionally, in other embodiments the second program unit is further configured to load default display data to the display region of the data to be loaded for display.

Further, in the other embodiments a third program unit is provided. The third program unit is configured to determine the anchor position on the display interface based on a display operation event, and determine the display region of the data to be loaded based on the anchor position. The third program unit is further configured to determine the anchor position on the display interface based on a gesture swipe operation event or a key operation event, wherein the gesture swipe operation event or the key operation event is used as the display operation event.

Further, in the other embodiments a fourth program unit is provided. The fourth program unit is configured to determine a plurality of peripheral display frameworks by extension outwards using the display framework corresponding to the anchor position as a reference, and load acquired different display data to the different peripheral display frameworks for display.

Further, in the other embodiments a fifth program unit is provided. The fifth program unit is configured to construct a display framework array on the display interface, wherein the display framework array comprises a plurality of display frameworks having different physical positions, a position identifier being assigned to each physical position.

Further, in the other embodiments a sixth program unit is provided. The sixth program unit is configured to acquire display data from a queue of the pre-acquired display data based on priorities, and load the acquired display data to the display region of the data to be loaded for display. The sixth program unit is further configured to match corresponding display data from the queue of the pre-acquired display data based on the display priorities and a dimension of the display region of the data to be loaded. The sixth program unit is further configured to match corresponding display data from the queue of the pre-acquired display data based on the display priorities and a dimension of the display region of the data to be loaded.

Further, in the other embodiments a seventh program unit is provided. The seventh program unit is configured to establish an association relationship between a physical position of the display region of the data to be loaded and a resource request sequence, and match the plurality of display data from the queue of the pre-acquired display data based on the display priorities.

Further, in the other embodiments an eighth program unit is provided. The eighth program unit is configured to pre-download a plurality of display data to a local front end in an anchoring process, and load the pre-downloaded display data to the display region of the data to be loaded for display. The eighth program unit is further configured to pre-download display data sets to the local front end during the anchoring process, each of the display data sets include a plurality of display data; and load the plurality of display data in each display data set to each display framework in the display region of the data to be loaded for display.

Further, in the other embodiments a ninth program unit is provided. The ninth program unit, configured to acquire a complete display data stream from a background, and fill the complete display data stream to a display frame.

It should be noted that the terms “first”, “second”, “third”, “fourth”, “fifth”, “sixth”, “seventh” and “eighth” used herein in this specification are not intended to limit the number of program units. Nevertheless, for persons of ordinary skills in the art, these program units may be reused, or the function set of one program unit may also be integrated on another program unit.

The apparatus described above in the embodiments is illustrative. The modules which are described as “being separate” may be physically separate or not. The component being displayed as a module may be or may be not a physical module. And the component may be located in a single place or distributed in a plurality of online modules. All or part of the modules may be chosen to achieve the object of this disclosure. A person skilled in the art would understand how to implement the apparatus without inventive efforts.

A person skilled in the art would understand, based on the description of the embodiments, that the embodiments may be implemented by software in combination with the necessary hardware platform. Thus, the essence of the embodiments or the part that the embodiments contribute to the prior art may be implemented in the form of a software product. The software product can be stored in a computer-readable storage medium. The computer-readable storage medium may be any medium or mechanism that can store and transmit information readable by a computer. For example, the computer-readable storage medium includes a read-only memory (ROM), a random access memory (RAM), a storage disk, an optical storage medium, a flash memory, electric, light, sound and other forms of transmitting information (for example, a signal carrier, an infrared signal, a digital signal etc.). The software product may have instructions so as to drive a computing device (for example, a personal computer, a server or a network device) to execute each of the embodiments or methods in some embodiments.

It should be noted that described above are merely preferred exemplary embodiments of the present disclosure and illustration of the technical principle of the present disclosure. A person skilled in the art should understand that the scope of the present disclosure is not limited to the technical solution defined by a combination of the above technical features, and shall further cover the other technical solutions defined by any combination of the above technical features and equivalent features thereof without departing from the inventive concept of the present disclosure.

A person skilled in the art would understand would understand that embodiments of the invention can be a method, an apparatus (device) or a product of a computer program. Thus, the embodiments of the invention can be implemented in the form of a hardware, software or combination thereof. Moreover, a product of a computer program that is executed in a computer-readable storage medium (including but not limited to a storage disk, CD-ROM and an optical storage medium, etc.) which includes program codes executable by a computer can be used to implement the embodiments.

The flowcharts and block diagrams in the accompanying drawings illustrate possibly practicable system architecture, functions and operations of the system, method and computer program product according to various embodiments of the present disclosure. In this sense, each block in the flowcharts or block diagrams may represent a module, a program segment or a portion of the code. The module, the program segment or the portion of the code includes one or more executable instructions for implementing specified logic functions. Specific sequence relationships are present in the above specific embodiments. However, these sequence relationships are merely exemplary, fewer and more steps may be performed or the sequence for performing these steps may be adjusted or changed. It should be noted that in some alternative implementations, the functions specified in the blocks may also be implemented in a sequence different from that illustrated in the accompanying drawings. For example, two continuous blocks may be practically performed substantially in parallel, and sometimes may be performed in a reverse sequence, which may depend on the functions involved. It should also be noted that each block in the block diagrams and/flowcharts and a combination of the blocks of the block diagrams and/or flowcharts may be implemented by using a dedicated hardware-based system for implementing the specified functions or operations, or may be implemented by using a combination of dedicated hardware and computer instructions.

The embodiments of the invention are described with reference to the flowcharts and/or block diagrams illustrating the methods, apparatus (device) and product of a computer program. It is understandable that each step and/or block of the flowcharts and/or block diagrams or combination of different steps and/or blocks can be implemented by computer program instructions. Such instructions can be provided to a general purpose or dedicated computer, a built-in processor or a programmable data processing apparatus to produce a machine, such that the instructions, which run via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement the functions specified in the flowchart and/or block diagram.

The computer program instructions may be stored in a computer-readable medium that may direct a computer or other programmable data processors to operate in a specified manner so as to implement the functions specified in each step and/or block of the flowcharts and/or block diagrams or combination of different steps and/or blocks.

The computer readable program instructions may also be loaded onto a computer or other programmable data processing apparatus to cause a series of operational steps to be performed on the computer or other programmable apparatus to produce a computer implemented process, such that the instructions which run on the computer or other programmable apparatus implement the functions specified in the flowchart and/or block diagram.

What is claimed is:

1. A display processing method, comprising:
determining a display region of data to be loaded based on an anchor position on a display interface; and
loading pre-acquired display data to the display region of the data to be loaded for display.

2. The method according to claim 1, further comprising: determining the anchor position on the display interface based on a display operation event, and determining the display region of the data to be loaded based on the anchor position.

3. The method according to claim 2, wherein the anchor position on the display interface is determined based on a gesture swipe operation event or a key operation event, wherein the gesture swipe operation event or the key operation event is used as the display operation event.

4. The method according to claim 1, wherein the determining a display region of data to be loaded based on an anchor position on a display interface comprises: determining a display framework corresponding to the anchor position based on the anchor position on the display interface and a physical position identifier of a display framework planed on the display interface, wherein the display region of the data to be loaded comprises the display frame corresponding to the anchor position.

5. The method according to claim 1, further comprising: determining a plurality of peripheral display frameworks by extension outwards using the display framework corresponding to the anchor position as a reference, and loading acquired different display data to the different peripheral display frameworks for display.

6. The method according to claim 1, further comprising: constructing a display framework array on the display interface, wherein the display framework array comprises a plurality of display frameworks having different physical positions, a position identifier being assigned to each physical position.

7. The method according to claim 1, further comprising: acquiring display data from a queue of the pre-acquired display data based on display priorities, and loading the acquired display data to the display region of the data to be loaded for display.

8. The method according to claim 7, wherein the acquiring display data from a queue of the pre-acquired display data based on display priorities comprises: matching corresponding display data from the queue of the pre-acquired display data based on the display priorities and a dimension of the display region of the data to be loaded.

9. The method according to claim 7, wherein the acquiring display data from a queue of the pre-acquired display data based on display priorities, and loading the acquired display data to a display framework corresponding to the anchor position for display comprises: matching a plurality of display data from the queue of the pre-acquired display data based on the display priorities, and loading the plurality of display data to a plurality of display frameworks in the display region of the data to be loaded for respectively display based on recommended priorities.

10. The method according to claim 9, further comprising: establishing an association relationship between a physical position of the display region of the data to be loaded and a resource request sequence, and matching the plurality of display data from the queue of the pre-acquired display data based on the display priorities.

11. The method according to claim 1, wherein the loading pre-acquired display data to the display region of the data to be loaded for display comprises: loading default display data to the display region of the data to be loaded for display.

12. The method according to claim 1, further comprising: pre-downloading a plurality of display data to a local front end in an anchoring process, and loading the pre-downloaded display data to the display region of the data to be loaded for display.

13. The method according to claim 12, wherein the pre-downloading a plurality of display data to a local front end in an anchoring process comprises: pre-downloading display data sets to the local front end during the anchoring process, each display data set comprising a plurality of display data; and loading the plurality of display data in each display data set to each display framework in the display region of the data to be loaded for display.

14. The method according to claim 1, further comprising: acquiring a complete display data stream from a background, and filling the complete display data stream to a display frame.

15. The method according to claim 14, wherein the display data is a cover display picture, and the display data stream is a video stream.

16. A display processing apparatus, comprising:
a first program unit, configured to determine a display region of data to be loaded based on an anchor position on a display interface; and
a second program unit, configured to load pre-acquired display data to the display region of the data to be loaded for display.

17. The apparatus according to claim 16, wherein the first program unit is further configured to determine a display framework corresponding to the anchor position based on the anchor position on the display interface and a physical position identifier of a display framework planed on the display interface, wherein the display region of the data to be loaded comprises the display frame corresponding to the anchor position.

18. The apparatus according to claim 16, further comprising: a fourth program unit, configured to determine a plurality of peripheral display frameworks by extension outwards using the display framework corresponding to the anchor position as a reference, and load acquired different display data to the different peripheral display frameworks for display.

19. The apparatus according to claim 16, further comprising: a seventh program unit, configured to establish an association relationship between a physical position of the display region of the data to be loaded and a resource request sequence, and match the plurality of display data from the queue of the pre-acquired display data based on the display priorities.

20. An electronic terminal, comprising a non-transitory storage memory and one or more processors in communication with the memory, wherein the storage memory stores computer-executable instructions, which, when being executed by the one or more processors, cause the one or more processors to perform the following steps:
determining a display region of data to be loaded based on an anchor position on a display interface; and
loading pre-acquired display data to the display region of the data to be loaded for display.
